(19) United States
(12) Patent Application Publication
(10) Pub. No.: US 2011/0121934 A1
(43) Pub. Date: May 26, 2011

(54) Lead Frame-based Discrete Power Inductor

(76) Inventors: Francois Hébert, San Mateo, CA (US); Tao Feng, Santa Clara, CA (US); Xiaotian Zhang, San Jose, CA (US); Jun Lu, San Jose, CA (US)

(21) Appl. No.: 13/021,347

(22) Filed: Feb. 4, 2011

Related U.S. Application Data
(63) Continuation of application No. 12/011,489, filed on Jan. 25, 2008, now Pat. No. 7,884,696.
Application No. 12/011,489 is a continuation-in-part of application No. 11/986,673, filed on Nov. 23, 2007, now Pat. No. 7,884,452.

(51) Int. Cl. H01F 5/04

(52) U.S. Cl. 336/200

(57) ABSTRACT

A lead frame-based discrete power inductor is disclosed. The power inductor includes top and bottom lead frames, the leads of which form a coil around a single closed-loop magnetic core. The coil includes interconnections between inner and outer contact sections of the top and bottom lead frames, the magnetic core being sandwiched between the top and bottom lead frames. Ones of the leads of the top and bottom lead frames have a generally non-linear, stepped configuration such that the leads of the top lead frame couple adjacent leads of the bottom lead frame about the magnetic core to form the coil.

### CROSS REFERENCE TO RELATED APPLICATIONS

The present invention is a continuation in part application of Ser. No. 11/986,673 filed on Nov. 23, 2007 and entitled “Semiconductor Power Device Package Having a Lead Frame-Based Integrated Inductor”, the entire disclosure of which is hereby incorporated by reference.

### BACKGROUND OF THE INVENTION

1. Field of the Invention

The present invention generally relates to discrete inductors and more particularly to a discrete inductor comprising top and bottom lead frames, the interconnected leads of which form a coil about a closed-loop magnetic core.

2. Description of the Related Art

A review of known discrete inductors reveals a variety of structures including encapsulated wire-wound inductors having either round or flat wire wound around a magnetic core. Exemplary magnetic cores include toriodal cores, “I” style drum cores, “T” style drum cores, and “E” style drum cores. Other known structures include wire wound devices having iron powder cores and metal alloy powder cores. It is also known to form a surface mount discrete inductor employing a wire wound around a magnetic core. The fabrication of wire wound inductors is an inefficient and complex process. Open spools are typically used to facilitate the winding of the wire around the drum core. In the case of toroidal cores, the wire must be repeatedly fed through the center hole.

Non-wire wound discrete inductors include solenoid coil conductors such as disclosed in U.S. Pat. No. 6,930,584 entitled “Microminiature Power Converter” and multi-layer inductors. Exemplary multi-layer inductors are disclosed in U.S. Pat. No. 4,543,553 entitled “Chip-type Inductor”, U.S. Pat. No. 5,032,815 entitled “Lamination Type Inductor”, U.S. Pat. No. 6,630,881 entitled “Method for Producing Multi-layered Chip Inductor”, and U.S. Pat. No. 7,046,114 entitled “Laminated Inductor”. These non-wire wound discrete inductors require multiple layers and are of complex structure and not easily manufacturable.

In view of the limitations of the prior art, there remains a need in the art for a discrete power inductor that is easily manufacturable in high volume using existing techniques. There is also a need in the art for a discrete power inductor that provides a low cost discrete power inductor. There is a further need in the art for discrete power inductor that maximizes the inductance per unit area and that minimizes resistance. There is also a need in the art for a compact discrete power inductor that combines a small physical size with a minimum number of turns to provide a small footprint and thin profile.

### SUMMARY OF THE INVENTION

The discrete power inductor of the invention overcomes the disadvantages of the prior art and achieves the objectives of the invention by providing a power inductor comprising top and bottom lead frames, the interconnected leads of which form a coil about a single closed-loop magnetic core. The single magnetic core layer maximizes the inductance per unit area of the power inductor.

In one aspect of the invention, the bottom lead frame includes a plurality of bottom leads each having first and second contact sections disposed at respective ends thereof. The bottom lead frame further includes a first terminal lead having a first contact section and a second terminal lead having a second contact section. The top lead frame includes a plurality of top leads each having first and second contact sections disposed at respective ends thereof.

In another aspect of the invention, the bottom lead frame includes a first side and a second side, the first and second sides being disposed opposite one another. A first set of leads comprises the first side and a second set of leads comprises the second side. The first set of leads includes a terminal lead having an inner contact section. The remaining leads of the first set of leads include inner and outer contact sections.

The bottom lead frame second set of leads includes a terminal lead having an outer contact section. The remaining leads of the second set of leads have inner and outer contact sections.

The bottom lead frame further includes a routing lead that extends between the first side and the second side. The routing lead has inner and outer contact sections.

The top lead frame includes a first side and a second side, the first and second sides being disposed opposite one another. A first set of leads comprises the first side and a second set of leads comprises the second side. Each of the top leads comprises an inner contact section and an outer contact section.

The coil about the single closed-loop magnetic core comprises interconnections between inner and outer contact sections of the top and bottom lead frames, the magnetic core being sandwiched between the top and bottom lead frames. Ones of the leads of the top and bottom lead frames have a generally non-linear, stepped configuration such that the leads of the top lead frame couple adjacent leads of the bottom lead frame about the magnetic core to form the coil.

In another aspect of the invention, the magnetic core is patterned with a window or hole in the center thereof to allow for connection between the inner contact sections of the top and bottom lead frame leads.

In another aspect of the invention, an interconnection structure or chip is disposed in the window of the magnetic core to facilitate connection between the inner contact sections of the top and bottom lead frame leads. The interconnection chip comprises conductive vias for coupling the inner contact sections.

In yet another aspect of the invention, a peripheral interconnection structure or chip is disposed in surrounding relationship to the magnetic core to facilitate connection between outer contact sections of the top and bottom lead frame leads. The peripheral interconnection chip comprises conductive vias for coupling the outer lead sections.

In still another aspect of the invention, the magnetic core is solid and conductive vias provide for connection between the inner contact sections of the top and bottom lead frame leads.

In yet another aspect of the invention, the magnetic core is solid and conductive vias provide for connection between the inner and outer contact sections of the top and bottom lead frame leads.

In still another aspect of the invention, leads of the top and bottom lead frames are bent such that the inner and outer contact sections thereof are disposed in a plane parallel to a plane of the lead frame.

In yet another aspect of the invention, the top leads are bent such that the inner and outer contact sections thereof are disposed in a plane parallel to the plane of the lead frame and the bottom leads are planar.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of functional components and to the arrangements of these components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1A is a top plan view of a first embodiment of a lead frame-based discrete power inductor in accordance with the invention;

FIG. 1B is a top plan view of the lead frame-based discrete power inductor of FIG. 1A showing a magnetic core in phantom;

FIG. 1C is a top plan view of the magnetic core in accordance with the invention;

FIG. 1D is a top plan view of the magnetic core with a small gap in accordance with the invention;

FIG. 1E is a top plan view of a bottom lead frame in accordance with the invention;

FIG. 1F is a top plan view of a top lead frame in accordance with the invention;

FIG. 1G is a side elevation view of the lead frame-based discrete power inductor of FIG. 1A;

FIG. 1H is a cross sectional view of a package encapsulating the lead frame-based discrete power inductor of FIG. 1A;

FIG. 2A is a top plan view of a second embodiment of the lead frame-based discrete power inductor in accordance with the invention;

FIG. 2B is a side elevation view of the lead frame-based discrete power inductor of FIG. 2A;

FIG. 2C is a top plan view of a bottom lead frame in accordance with the invention;

FIG. 2D is a cross sectional view of a package encapsulating the lead frame-based discrete power inductor of FIG. 2A;

FIG. 3A is a top plan view of a third embodiment of the lead frame-based discrete power inductor in accordance with the invention;

FIG. 3B is a top plan view of a top lead frame in accordance with the invention;

FIG. 3C is a schematic side elevation view a the lead frame-based discrete power inductor of FIG. 3A;

FIG. 3D is a top plan view of an interconnection chip in accordance with the invention;

FIG. 3E is a cross sectional view of the interconnection chip of FIG. 3D;

FIG. 4A is a top plan view of a fourth embodiment of the lead frame-based discrete power inductor in accordance with the invention;

FIG. 4B is a top plan view of a bottom lead frame in accordance with the invention;

FIG. 5A is a top plan view of a fifth embodiment of the lead frame-based discrete power inductor in accordance with the invention;

FIG. 5B is a schematic side elevation view of the lead frame-based discrete power inductor of FIG. 5A;

FIG. 5C is a top plan view of a peripheral interconnection chip in accordance with the invention;

FIG. 5D is a top plan view of a top lead frame in accordance with the invention;

FIG. 6A is a top plan view of a sixth embodiment of the lead frame-based discrete power inductor in accordance with the invention;

FIG. 6B is a top plan view of a magnetic core in accordance with the invention;

FIG. 6C is a side elevation view of the lead frame-based discrete power inductor of FIG. 6A;

FIG. 6D is a top plan view of a bottom lead frame in accordance with the invention;

FIG. 7A is a top plan view of a seventh embodiment of the lead frame-based discrete power inductor in accordance with the invention;

FIG. 7B is a side elevation view of the lead frame-based discrete power inductor of FIG. 7A;

FIG. 8A is a top plan view of an eighth embodiment of the lead frame-based discrete power inductor in accordance with the invention;

FIG. 8B is a top plan view of a magnetic core in accordance with the invention;

FIG. 8C is a side elevation view of the lead frame-based discrete power inductor of FIG. 8A;

FIG. 9A is a top plan view of a ninth embodiment of the lead frame-based discrete power inductor in accordance with the invention;

FIG. 9B is a top plan view of a magnetic core in accordance with the invention;

FIG. 9C is a top plan view of a bottom lead frame in accordance with the invention; and

FIG. 9D is a top plan view of a top lead frame in accordance with the invention.

### DETAILED DESCRIPTION OF A PREFERRED EMBODIMENT OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

The present invention provides a lead frame-based discrete power inductor. Embodiments of the invention include a magnetic core having a window or hole formed in a center thereof to allow for connection between inner contact sections of top and bottom lead frame leads to thereby form a coil of the power inductor as further described herein. The magnetic core is preferably of toroidal configuration and as thin as 100 microns in thickness, for applications requiring thin inductors. The magnetic core may be formed of ferrite or nanocrystalline NiFe for high frequency applications and of NiFe, NiZn or other suitable magnetic materials for low frequency applications. One of the primary applications considered for the discrete power inductors described herein, is for use in DC-DC power converters which operate in the 1 MHz to 5 MHz range, with output currents of 1 A or below, with inductance values in the 0.4 to 2.0 uH range, and DC series resistance of less than 0.15 ohms. The coil of the power inductor in accordance with the invention is comprised of interconnected contact sections of the leads of the top and bottom lead frames about the magnetic core. The interconnection may be accomplished using standard semiconductor packaging material techniques including soldering and the use of conductive epoxies. The top and bottom lead frames are preferably between 100 and 200 microns thick and formed from a low resistance material including copper and other conventional alloys used in the fabrication of lead frames. Combined with the magnetic core, the total thickness of the power inductor in accordance with the invention can be much less than 1 mm if necessary, which is desirable for many applications such as hand-held devices and portable electronic products.

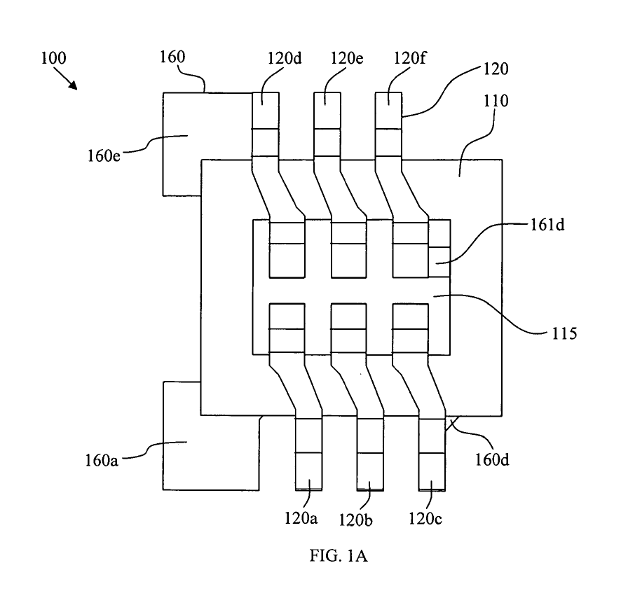

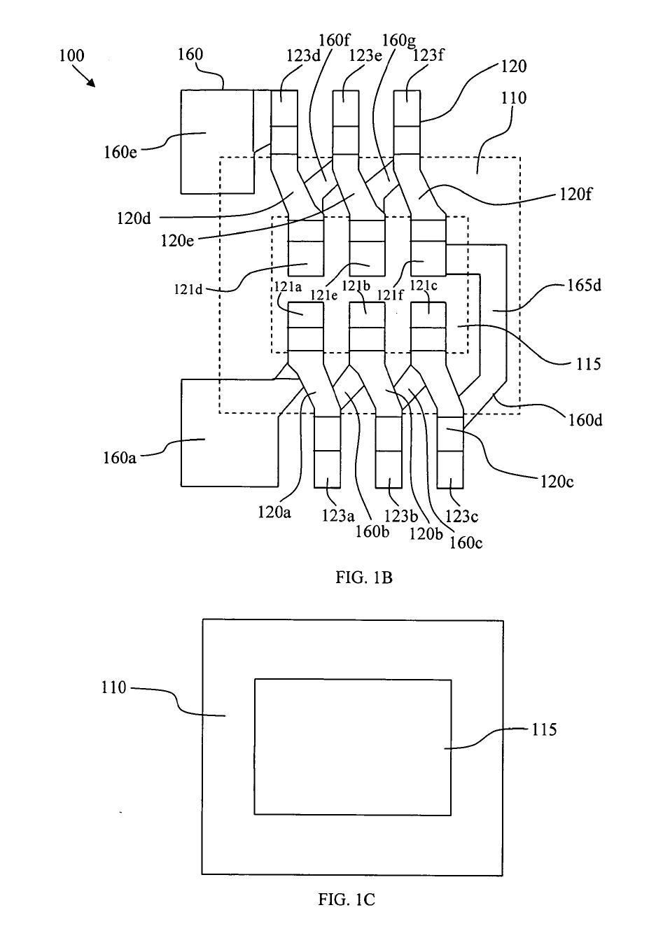

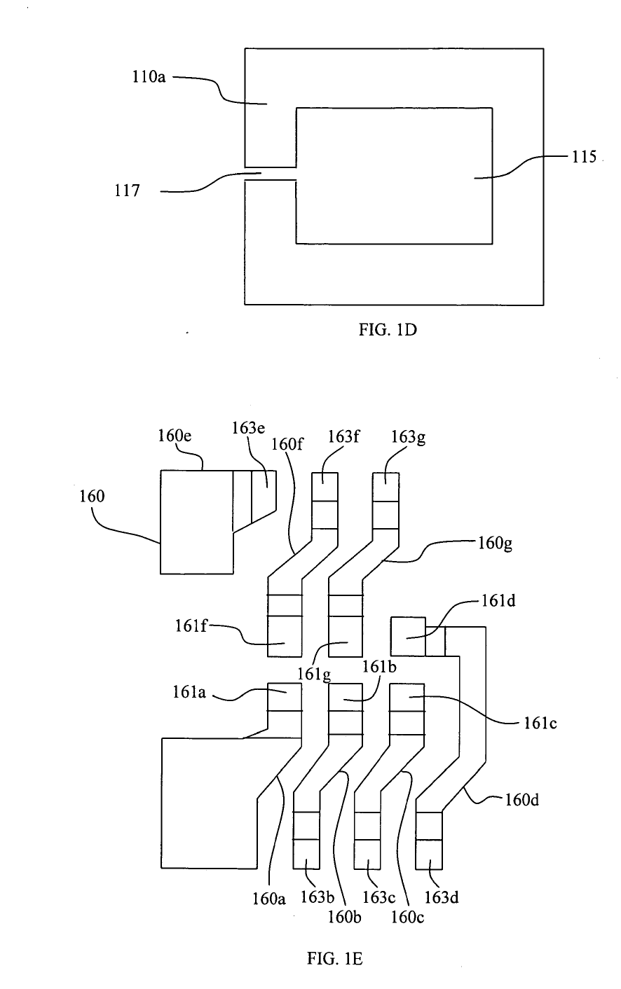

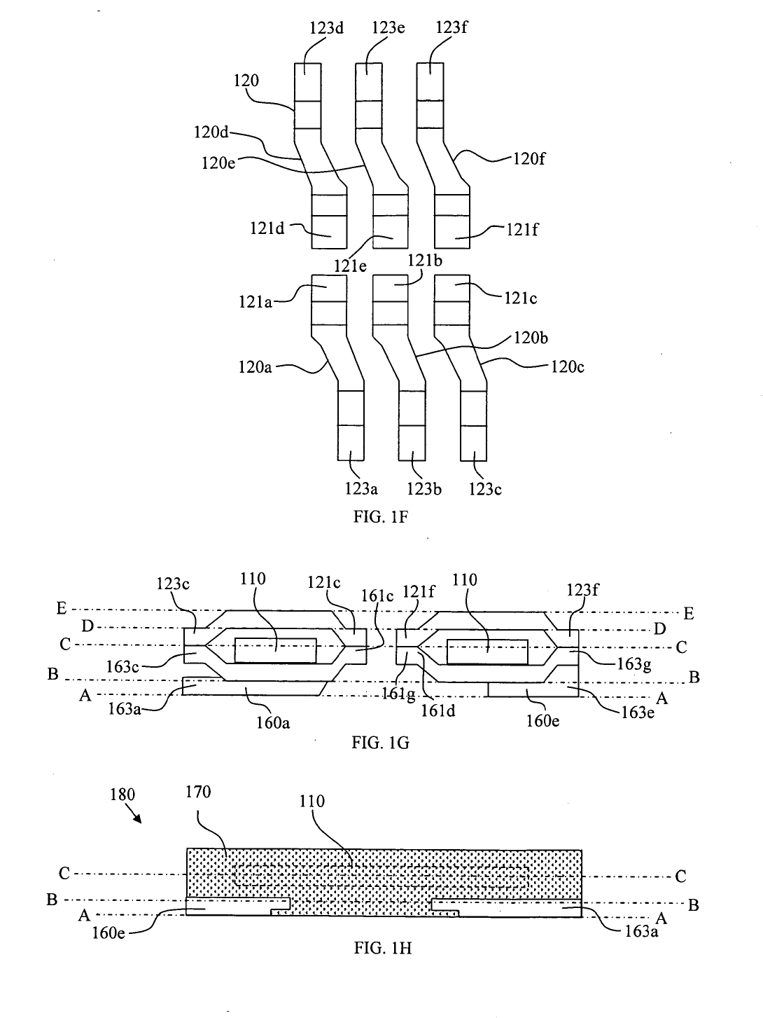

A first embodiment of a lead frame-based discrete power inductor generally designated 100 is shown in FIG. 1A. The inductor 100 comprises a magnetic core 110, a top lead frame 120 and a bottom lead frame 160, the leads of which are interconnected about the magnetic core 110. The lead frame 160 is made of a conductive material, preferably metallic, including copper, Alloy 42, and plated copper. The magnetic core 110 includes a window or hole 115 formed in a center thereof (FIG. 1C).

With reference to FIG. 1D, a magnetic core 110a is shown including a small gap 117. The gap 117 can be used to adjust the properties of the magnetic core 110a with the resulting structure still providing a closed magnetic loop. The gap 117 can also be partial like a slot, in addition to extending completely through a side of the magnetic core. In all embodiments of this invention, a magnetic core either with or without a gap can be used.

Top and bottom lead frames 120 and 160 each comprise a plurality of leads. With particular reference to FIG. 1E, the bottom lead frame 160 includes a first set of leads 160a, 160b, and 160c disposed on a first side of the lead frame 160. Leads 160a, 160b and 160c have a non-linear, stepped configuration to facilitate connection with leads of the top lead frame 120 to form the coil as further disclosed herein. The lead 160a serves as a terminal lead and has an inner contact section 161a disposed on a plane C-C parallel to, and above, a bottom plane A-A of the bottom lead frame 160. A simplified schematic side elevation view of the power inductor 100 is shown in FIG. 1G and illustrates the referenced planes and configuration of the leads. The lead 160f and parts of the magnetic core 110 are omitted from FIG. 1G to give a simplified and clearer illustration of the side profile of this embodiment. Similar simplifications are made in other side elevation views in this disclosure. Bottom leads 160b and 160c include inner contact sections 161b and 161c respectively disposed on the plane C-C that is parallel to, and above, a plane B-B of planar portions of the leads 160b and 160c. Bottom leads 160b and 160c further include outer contact sections 163b and 163c respectively disposed on the plane C-C. Plane B-B may be in the same plane or slightly above plane A-A.

The bottom lead frame 160 further includes a second set of leads 160e, 160f and 160g disposed on a second side of the lead frame 160. Leads 160e, 160f and 160g have a non-linear, stepped configuration to facilitate connection with leads of the top lead frame 120 to form the coil as further disclosed herein. The lead 160e serves as a terminal lead and has an outer contact section 163e disposed on the plane C-C. Bottom leads 160f and 160g include inner contact sections 161f and 161g respectively disposed on the plane C-C. Bottom leads 160f and 160g further include outer contact sections 163f and 163g respectively disposed on the plane C-C. The configuration of the leads of the bottom lead frame 160 provides a trough in which the magnetic core 110 is disposed in the assembled power inductor 100.

The bottom lead frame 160 also includes a routing lead 160d shown in FIG. 1E. Routing lead 160d includes an inner contact section 161d and an outer contact section 163d disposed on the plane C-C. A routing section 165d (disposed on the plane B-B) couples the outer contact section 163d disposed on the first side of the bottom lead frame 160 to the inner contact section 161d disposed on the second side of the bottom lead frame 160.

With reference to FIG. 1F, the top lead frame 120 includes a first set of leads 120a, 120b and 120c disposed on a first side of the top lead frame 120. Top leads 120a, 120b and 120c have a non-linear, stepped configuration to facilitate connection with leads of the bottom lead frame 160 to form the coil as further disclosed herein. Top leads 120a, 120b and 120c include inner contact sections 121a, 121b and 121c respectively disposed on the plane D-D that is parallel to, and below, a plane E-E of planar portions of the top leads 120a, 120b and 120c. Top leads 120a, 120b and 120c further include outer contact sections 123a, 123b and 123c respectively disposed on the plane D-D.

Top lead frame 120 further includes a second set of leads 120d, 120e and 120f disposed on a second side of the top lead frame 120. Top leads 120d, 120e and 120f have a non-linear, stepped configuration to facilitate connection with leads of the bottom lead frame 160 to form the coil as further disclosed herein. Top leads 120d, 120e and 120f include inner contact sections 121d, 121e and 121f respectively disposed on the plane D-D. Top leads 120d, 120e and 120f further include outer contact sections 123d, 123e and 123f respectively disposed on the plane D-D. The configuration of the leads of the top lead frame 120 provides a cover to the trough formed by the leads of the bottom lead frame 160 in which the magnetic core 110 is disposed in the assembled power inductor 100. The connection about the magnetic core 110 of the leads of the top and bottom lead frames 120 and 160 respectively provides the coil.

The coil is formed around the magnetic core 110 as shown most clearly in FIG. 1B in which the magnetic core 110 is shown in phantom lines. The inner contact sections of the leads 160a, 160b, 160c, 160d, 160f and 160g of the bottom lead frame 160 are coupled to the inner contact sections 121a, 121b, 121c, 121d, 121e and 121f through the window 115 of the magnetic core 110. The outer contact sections of the leads 160b, 160c, 160d, 160e, 160f and 160g of the bottom lead frame 160 are coupled to the outer contact sections 123a, 123b, 123c, 123d, 123e and 123f of the top lead frame 120 around a periphery of the magnetic core 110.

The inner contact section 161a of the lead 160a is coupled to the inner contact section 121a of the lead 120a. The outer contact section 123a of the lead 120a is coupled to the outer contact section 163b of the adjacent lead 160b. The non-linear, stepped configuration of the lead 120a enables the alignment and coupling of the outer contact sections 123a and 163b. The inner contact section 161b of the lead 160b is coupled to the inner contact section 121b of the lead 120b. The non-linear, stepped configuration of the lead 160b is such that the inner contact section 161b of the lead 160b is disposed adjacent the inner contact section 161a within the window 115. The outer contact section 123b of the lead 120b is coupled to the outer contact section 163c of the adjacent lead 160c. As in the case of the lead 120a, the non-linear, stepped configuration of the lead 120b enables the alignment and coupling of the outer contact sections 123b and 163c. The inner contact section 161c of the lead 160c is coupled to the inner contact section 121c of the lead 120c. The non-linear, stepped configuration of the lead 160c is such that the inner contact section 161c of the lead 160c is disposed adjacent the inner contact section 161b within the window 115. The outer contact section 123c of the lead 120c is coupled to the outer contact section 163d of the adjacent lead 160d, the non-linear, stepped configuration of the lead 120c enabling the alignment and coupling of the outer contact sections 123c and 163d.

The routing section 165d of the routing lead 160d routes the coil circuit to connect the inner contact section 161d of the lead 160d to the inner contact section 121f of the lead 120f. The outer contact section 123f of the lead 120f is coupled to the outer contact section 163g of the adjacent lead 160g. The non-linear, stepped configuration of the lead 120f enables the alignment and coupling of the outer contact sections 123f and 163g. The inner contact section 161g of the lead 160g is coupled to the inner contact section 121e of the lead 120e. The non-linear, stepped configuration of the lead 160g is such that the inner contact section 161g of the lead 160g is disposed adjacent the inner contact section 161d within the window 115. The outer contact section 123e of the lead 120e is coupled to the outer contact section 163f of the adjacent lead 160f. The non-linear, stepped configuration of the lead 120e enables the alignment and coupling of the outer contact sections 123e and 163f. The inner contact section 161f of the lead 160f is coupled to the inner contact section 121d of the lead 120d. The non-linear, stepped configuration of the lead 160f is such that the inner contact section 161f of the lead 160f is disposed adjacent the inner contact section 161g within the window 115. The outer contact section 123d of the lead 120d is coupled to the outer contact section 161e of the adjacent terminal lead 160e.

The discrete power inductor 100 may include terminals 160a and 160e, the interconnection between the leads of the top and bottom lead frames 120 and 160 forming the coil about the magnetic core 110.

The discrete power inductor 100 may be encapsulated with an encapsulant 170 to form a surface mount compatible package 180 (FIG. 1H). The encapsulant 170 may include conventional encapsulating materials. Alternatively, the encapsulant may include materials incorporating magnetic powders such as ferrite particles to provide shielding and improved magnetic performance. In case plane B-B is slightly above plane A-A, only portions of terminals 160a and 160e will exposed through the bottom surface of encapsulant 170 for outside connection and the rest of the bottom lead frame 160 may be covered by encapsulant 170.

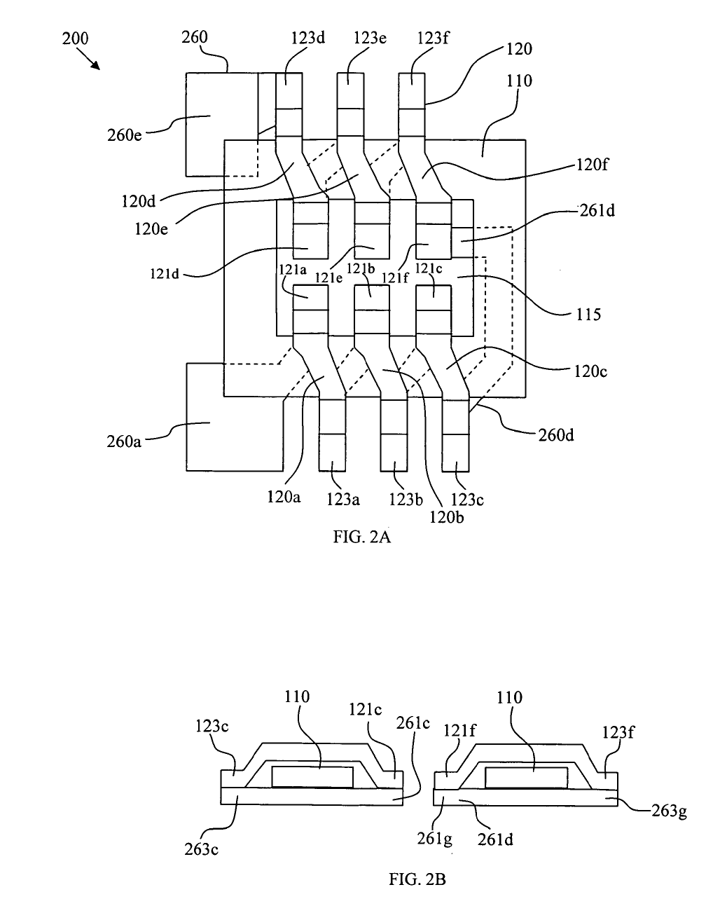

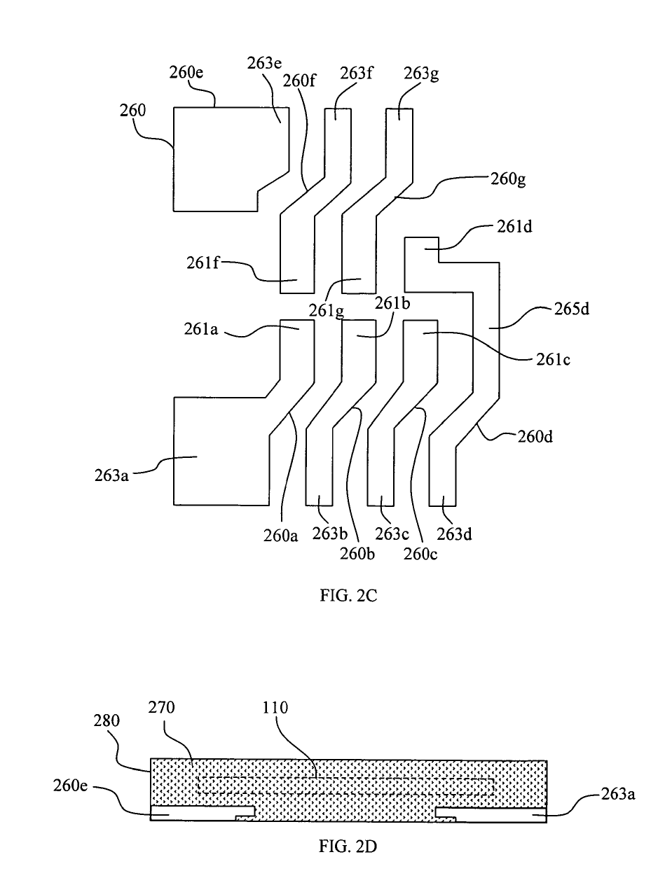

A second embodiment of a lead frame-based discrete power inductor generally designated 200 is shown in FIG. 2A wherein portions of the leads of the bottom lead frame 260 are shown in phantom lines. The power inductor 200 is in all respects identical to the power inductor 100 with the exception that the bottom lead frame 260 is planar as shown in the simplified schematic side elevation view (FIG. 2B) of the power inductor 200.

With particular reference to FIG. 2C, the bottom lead frame 260 includes a first set of leads 260a, 260b and 260c disposed on a first side of the lead frame 260. Leads 260a, 260b and 260c have a non-linear, stepped configuration to facilitate connection with leads of the top lead frame 120 to form the coil as further disclosed herein. The lead 260a serves as a terminal lead and has an inner contact section 261a. Bottom leads 260b and 260c include inner contact sections 261b and 261c respectively. Bottom leads 160b and 160c further include outer contact sections 163b and 163c respectively.

The bottom lead frame 260 further includes a second set of leads 260e, 260f and 260g disposed on a second side of the lead frame 260. Leads 260e, 260f and 260g have a non-linear, stepped configuration to facilitate connection with leads of the top lead frame 120 to form the coil as further disclosed herein. The lead 260e serves as a terminal lead and has an outer contact section 263e. Bottom leads 260f and 260g include inner contact sections 261f and 261g respectively. Bottom leads 260f and 260g further include outer contact sections 263f and 263g respectively. The configuration of the leads of the bottom lead frame 260 provides a platform on which the magnetic core 110 is disposed in the assembled power inductor 200.

The bottom lead frame 260 also includes a routing lead 260d shown in FIG. 2C. Routing lead 260d includes an inner contact section 261d and an outer contact section 263d. A routing section 265d couples the outer contact section 263d disposed on the first side of the bottom lead frame 260 to the inner contact section 261d disposed on the second side of the bottom lead frame 260.

A coil is formed about the magnetic core 110 as shown in FIG. 2A. The inner contact sections of the leads 260a, 260b, 260c, 260d, 260f and 260g of the bottom lead frame 260 are coupled to the inner contact sections 121a, 121b, 121c, 121d, 121e and 121f through the window 115 of the magnetic core 110. The outer contact sections of the leads 260b, 260c, 260d, 260e, 260f and 260g of the bottom lead frame 260 are coupled to the outer contact sections 123a, 123b, 123c, 123d, 123e and 123f of the top lead frame 120 around a periphery of the magnetic core 110.

The inner contact section 261a of the lead 260a is coupled to the inner contact section 121a of the lead 120a. The outer section 123a of the lead 120a is coupled to the outer section 263b of the adjacent lead 260b. The non-linear, stepped configuration of the lead 120a enables the alignment and coupling of the outer contact sections 123a and 263b. The inner contact section 261b of the lead 260b is coupled to the inner contact section 121b of the lead 120b. The non-linear, stepped configuration of the lead 260b is such that the inner contact section 261b of the lead 260b is disposed adjacent the inner contact section 261a within the window 115. The outer contact section 123b of the lead 120b is coupled to the outer contact section 263c of the adjacent lead 260c. The non-linear, stepped configuration of the lead 120b enables the alignment and coupling of the outer contact sections 123b and 263c. The inner contact section 261c of the lead 260c is coupled to the inner section 121c of the lead 120c. The non-linear, stepped configuration of the lead 260c is such that the inner contact section 261c of the lead 260c is disposed adjacent the inner contact section 261b within the window 115. The outer contact section 123c of the lead 120c is coupled to the outer contact section 263d of the adjacent lead 260d.

The routing lead 260d comprises a routing section 265d (FIG. 2C) that routes the coil circuit to connect the inner contact section 261d of the lead 260d to the inner contact section 121f of the lead 120f. The outer contact section 123f of the lead 120f is coupled to the outer contact section 263g of the lead 260g. The non-linear, stepped configuration of the lead 120f enables the alignment and coupling of the outer contact sections 123f and 263g. The inner contact section 261g of the lead 260g is coupled to the inner contact section 121e of the adjacent lead 121e. The non-linear, stepped configuration of the lead 260g is such that the inner contact section 261g of the lead 260g is disposed adjacent the inner contact section 261d within the window 115. The outer contact section 123e of the lead 120e is coupled to the outer contact section 263f of the adjacent lead 260f. The non-linear, stepped configuration of the lead 120e enables the alignment and coupling of the outer contact sections 123e and 263f. The inner contact section 261f of the lead 260f is coupled to the inner contact section 121d of the lead 120d. The non-linear, stepped configuration of the lead 260f is such that the inner contact section 261f of the lead 260f is disposed adjacent the inner contact section 261g within the window 115. The outer contact section 123d of the lead 120d is coupled to the out contact section 263 of lead 260e.

The discrete power inductor 200 may include terminals 260a and 260e, the interconnection between the leads of the top and bottom lead frames 120 and 260 forming the coil about the magnetic core 110.

The discrete power inductor 200 may be encapsulated with an encapsulant 270 to form a package 280 (FIG. 2D). The encapsulant 270 may include conventional encapsulating materials. Alternatively, the encapsulant may include materials incorporating magnetic powders such as ferrite particles to provide shielding and improved magnetic performance.

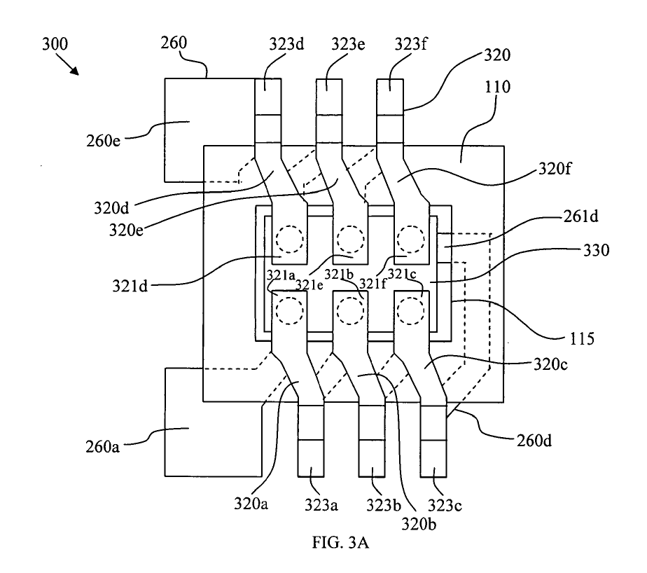

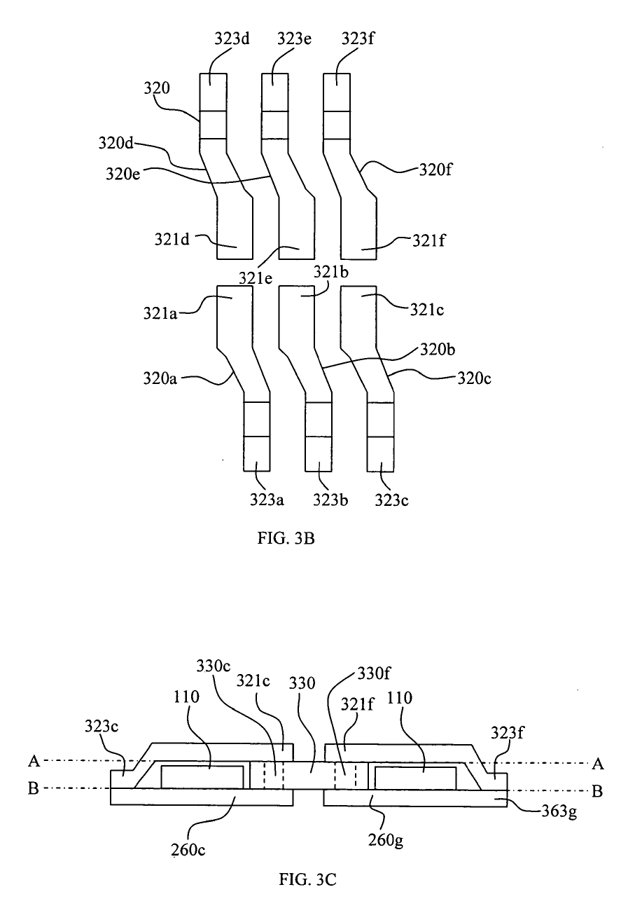

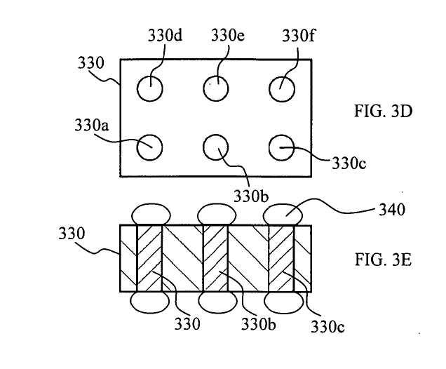

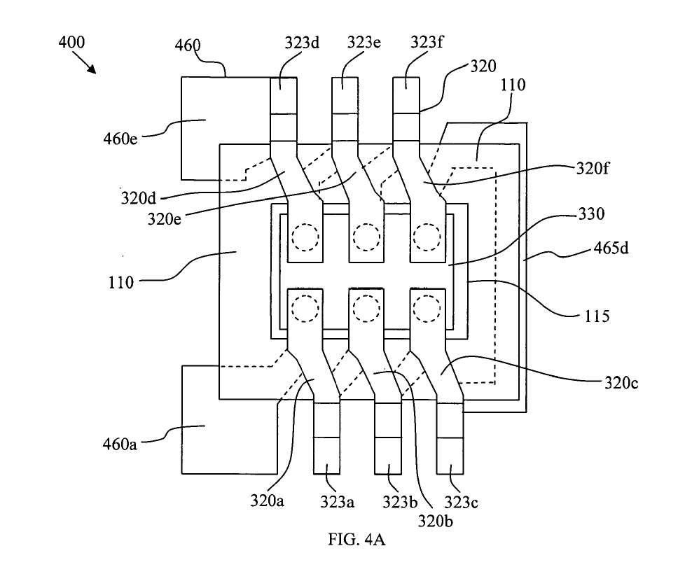

A third embodiment of a lead frame-based discrete power inductor generally designated 300 is shown in FIG. 3A wherein portions of the leads of the bottom lead frame 260 are shown in phantom lines. Power inductor 300 comprises the planar bottom lead frame 260, a top lead frame 320, the leads of which are interconnected about the magnetic core 110. An interconnection chip 330 is disposed in the window 115 (FIG. 3C) and enables connection between the inner contact sections of the top and bottom lead frame leads.

With reference to FIG. 3B, the top lead frame 320 includes a first set of leads 320a, 320b and 320c disposed on a first side of the top lead frame 120. Top leads 320a, 320b and 320c have a non-linear, stepped configuration to facilitate connection with leads of the bottom lead frame 260 to form the coil as further disclosed herein. Top leads 320a, 320b and 320c include inner contact sections 321a, 321b and 321c respectively disposed on a plane A-A of planar portions of the top leads 320a, 320b and 320c. Top leads 320a, 320b and 320c further include outer contact sections 323a, 323b and 323c respectively disposed on a plane B-B parallel, and below the plane A-A.

Top lead frame 320 further includes a second set of leads 320d, 320e and 320f disposed on a second side of the top lead frame 320. Top leads 320d, 320e and 320f have a non-linear, stepped configuration to facilitate connection with leads of the bottom lead frame 260 to form the coil as further disclosed herein. Top leads 320d, 320e and 320f include inner contact sections 321d, 321e and 321f respectively disposed on the A-A. Top leads 320d, 320e and 320f further include outer contact sections 323d, 323e and 323f respectively disposed on the plane B-B. The connection about the magnetic core 110 of the leads of the top and bottom lead frames 320 and 260 respectively provides the coil.

The interconnection chip 330 is shown in FIG. 3D and FIG. 3E and includes six conductive through vias 330a, 330b, 330c, 330d, 330e and 330f (shown in phantom lines in FIG. 3A) spaced and configured to provide interconnection between the inner contact sections of the leads of the top lead frame 320 and the bottom lead frame 260. Solder bumps 340 are preferably formed on top and bottom surfaces of the interconnection chip 330 to facilitate interconnection.

A coil is formed about the magnetic core 110 as shown in FIG. 3A. The inner contact sections of the leads 260a, 260b, 260c, 260d, 260f and 260g of the bottom lead frame 260 are coupled to the inner contact sections 321a, 321b, 321c, 321d, 321e and 321f of the top lead frame 320 by means of the interconnection chip 330. The outer contact sections of the leads 260b, 260c, 260d, 260e, 260f and 260g of the bottom lead frame 260 are coupled to the outer contact sections 323a, 323b, 323c, 323d, 323e and 323f of the top lead frame 320 around a periphery of the magnetic core 110.

The inner contact section 261a of the lead 260a is coupled to the inner contact section 321a of the lead 320a by means of via 330a. The outer contact section 323a of the lead 320a is coupled to the outer contact section 263b of the adjacent lead 260b. The inner contact section 261b of the lead 260b is coupled to the inner contact section 321b of the lead 320b by means of via 330b. The outer contact section 323b of the lead 320b is coupled to the outer contact section 263c of the adjacent lead 260c. The inner contact section 261c of the lead 260c is coupled to the inner contact section 321c of the lead 320c by means of via 330c. The outer contact section 322c of the lead 320c is coupled to the outer contact section 263d of the adjacent lead 260d. The routing section 265d (FIG. 2C) routes the coil circuit to connect the inner contact section 261d of the lead 260d to the inner contact section 321f of the lead 320f by means of via 330f. The outer contact section 323f of the lead 320f is coupled to the outer contact section 263g of the adjacent lead 260g. The inner contact section 261g of the lead 260g is coupled to the inner contact section 321e of the lead 320e by means of via 330e. The outer contact section 323e of the lead 320e is coupled to the outer contact section 263f of the adjacent lead 260f. The inner contact section 261f of the lead 260f is coupled to the inner contact section 321d of the lead 320d by means of via 330d. The outer contact section 323d of the lead 320d is coupled to the outer contact section 263e of the adjacent lead 260e. As in the first and second embodiments, the non-linear, stepped configurations of the top and bottom lead frame leads provide for alignment and spacing of the inner and outer contact sections.

The discrete power inductor 300 may include terminals 260a and 260e, the interconnection between the leads of the top and bottom lead frames 320 and 260 facilitated by the interconnection chip 330 forming the coil about the magnetic core 110.

The discrete power inductor 300 may be encapsulated with an encapsulant to form a package (not shown). The encapsulant may include conventional encapsulating materials. Alternatively, the encapsulant may include materials incorporating magnetic powders such as ferrite particles to provide shielding and improved magnetic performance.

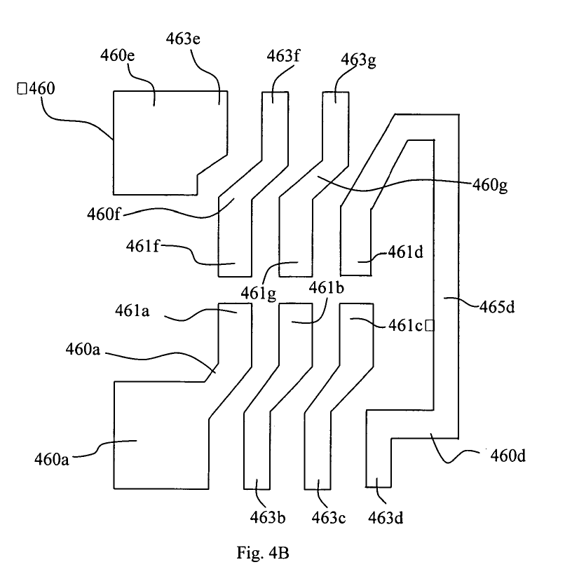

A fourth embodiment of a lead frame-based discrete power inductor generally designated 400 is shown in FIG. 4A wherein portions of the leads of a bottom lead frame 460 are shown in phantom lines. The power inductor 400 is in all respects identical to the power inductor 300 with the exception that the bottom lead frame 460 (FIG. 4B) comprises a routing lead 460d having a routing section 465d terminating in an inner section 461d aligned in parallel with an inner section 461g of a lead 460g.

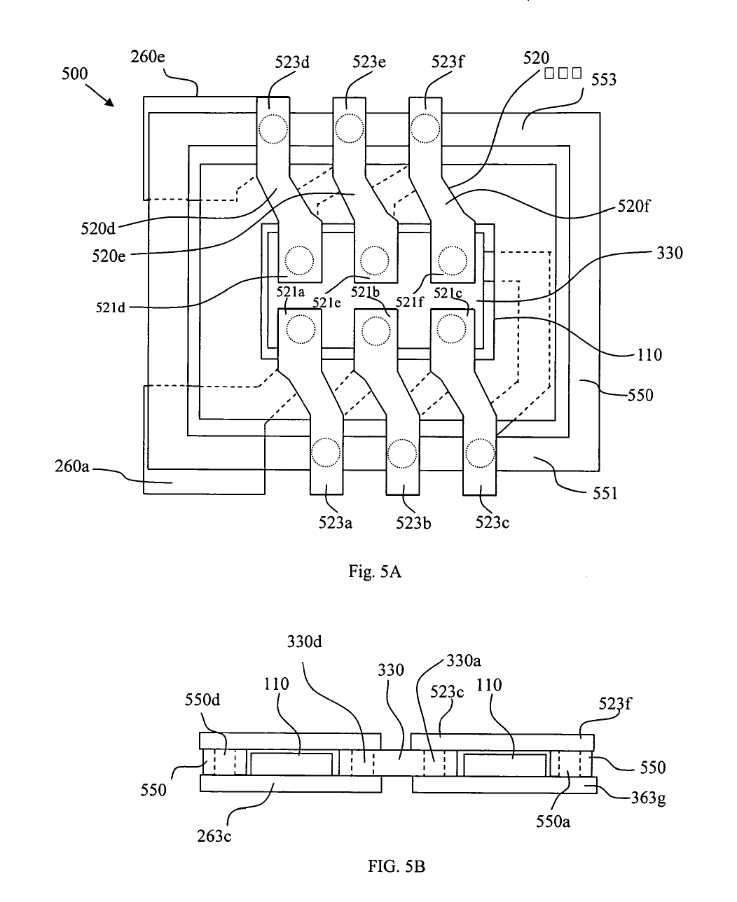

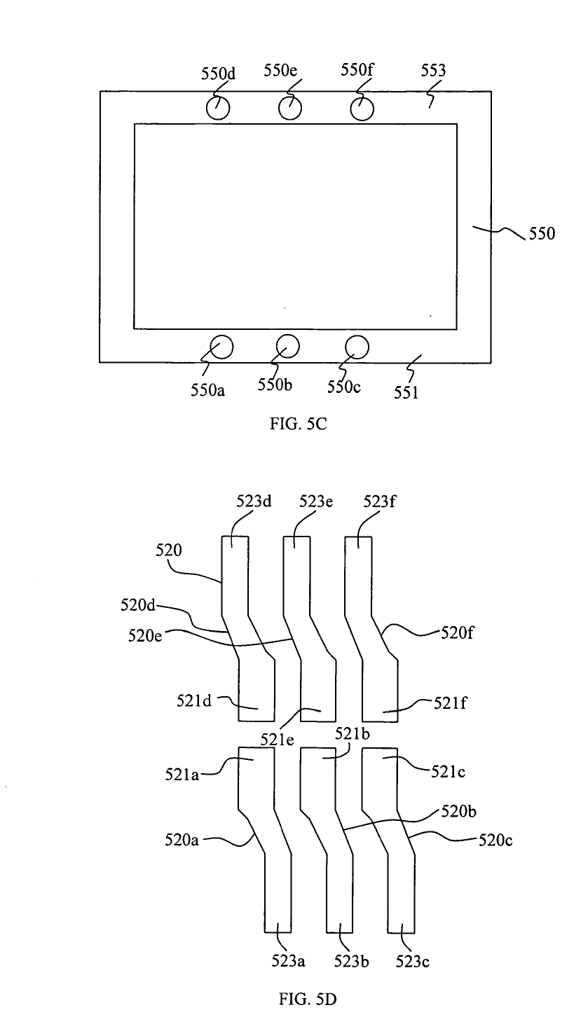

A fifth embodiment of a lead frame-based discrete power inductor generally designated 500 is shown in FIG. 5A and FIG. 5B wherein portions of the leads of the bottom lead frame 260 are shown in phantom lines. The power inductor 500 comprises a magnetic core 110, a top lead frame 520 (FIG. 5D), and the bottom lead frame 260, the leads of which are interconnected about the magnetic core 110. The interconnection chip 330 is disposed in the window 115 (FIG. 3C) and enables connection between the inner contact sections of the top and bottom lead frame leads. A peripheral interconnection chip 550 enables connection between the outer contact sections of the top and bottom lead frame leads.

The top lead frame 520 comprises a planar lead frame comprising a first set of leads 520a, 520b and 520c disposed on a first side of the lead frame 520. A second set of leads 520d, 520e and 520f are disposed on a second side of the lead frame. Lead 520a includes an inner contact section 121a and an outer contact section 123a. Lead 120b includes an inner contact section 121b and an outer contact section 123b. Lead 120d includes an inner contact section 121d and an outer contact section 123d. Lead 120e includes an inner contact section 121e and an outer contact section 123e. Lead 120f includes an inner contact section 121f and an outer contact section 123f. Top leads 520a, 520b, 520c, 520d, 520e and 520f have a non-linear, stepped configuration to facilitate connection with leads of the bottom lead frame 260 to form the coil as previously described.

The peripheral interconnection chip 550 comprises a rectangular shaped structure having conductive through vias 550a, 550b, 550c, 550d, 550e and 550f. Vias 550a, 550b and 550c are disposed in spaced relationship along a first section 551 of the peripheral interconnection chip 550. Vias 550d, 550e and 550f are disposed in spaced relationship along a second section 553 of the peripheral interconnection chip 550. The vias 550a, 550b, 550c, 550d, 550e and 550f are spaced and configured to provide interconnection between the outer contact sections of the leads of the top lead frame 520 and the bottom lead frame 260.

A coil is formed about the magnetic core 110 as shown in FIG. 5A. An inner contact section 261a of the lead 260a is coupled to the inner contact section 521a of the lead 520a by means of via 330a. The outer contact section 523a of the lead 520a is coupled to the outer contact section 263b of the adjacent lead 260b by means of via 550a. The inner contact section 261b of the lead 260b is coupled to the inner contact section 521b of the lead 520b by means of via 330b. The outer contact section 523b of the lead 520b is coupled to the outer contact section 263c of the adjacent lead 260c by means of via 550b. The inner contact section 261c of the lead 260c is coupled to the inner contact section 521c of the lead 520c by means of via 330c. The outer contact section 523c of the lead 520c is coupled to the outer contact section 263d of the adjacent lead 260d by means of via 550c. The routing section 265d (FIG. 2C) routes the coil circuit to connect the inner contact section 261d of the lead 260d to the inner contact section 521f of the lead 520f by means of via 330f. The outer contact section 523f of the lead 520f is coupled to the outer contact section 263g of the adjacent lead 260g by means of via 550f. The inner contact section 261g of the lead 260g is coupled to the inner contact section 521e of the lead 520e by means of via 330e. The outer contact section 523e of the lead 520e is coupled to the outer contact section 263f of the adjacent lead 260f by means of via 550e. The inner contact section 261f of the lead 260f is coupled to the inner contact section 521d of the lead 520d by means of via 330d. The outer contact section 523d of the lead 520d is coupled to the outer contact section 263e of the adjacent lead 260e by means of via 550d. As in the previously described embodiments, the non-linear, stepped configurations of the top and bottom lead frame leads provide for alignment and spacing of the inner and outer contact sections.

The discrete power inductor 500 may include terminals 260a and 260e, the interconnection between the leads of the top and bottom lead frames 520 and 260 facilitated by the interconnection chip 330 and the peripheral interconnection chip 550 forming the coil about the magnetic core 110.

The discrete power inductor 500 may be encapsulated with an encapsulant to form a package (not shown). The encapsulant may include conventional encapsulating materials. Alternatively, the encapsulant may include materials incorporating magnetic powders such as ferrite particles to provide shielding and improved magnetic performance.

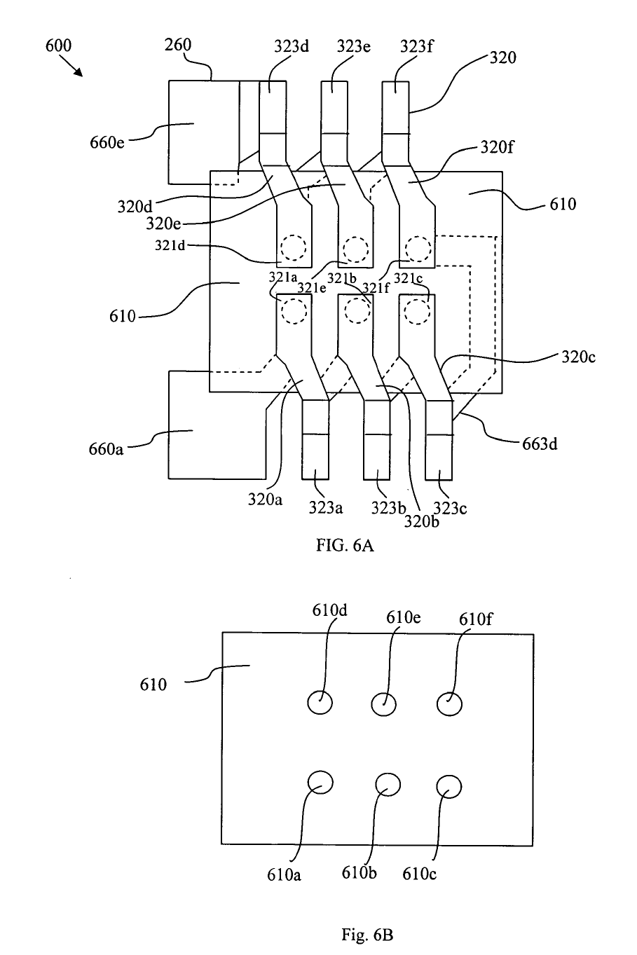

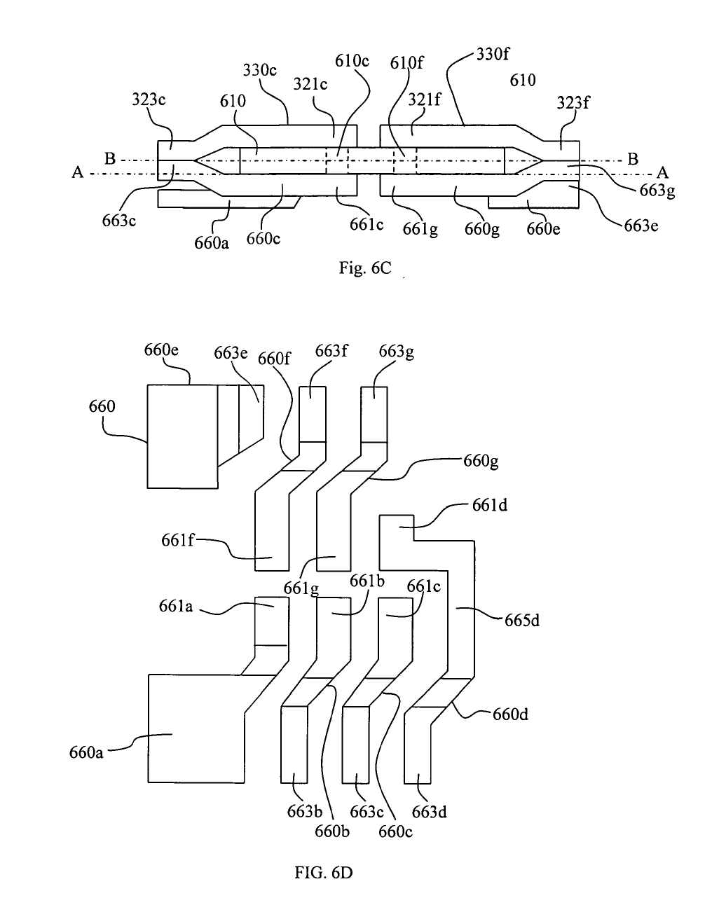

A sixth embodiment of a lead frame-based discrete power inductor generally designated 600 is shown in FIG. 6A wherein portions of the leads of a bottom lead frame 660 are shown in phantom lines. The power inductor 600 comprises a magnetic core 610, the top lead frame 320 and the bottom lead frame 660, the leads of which are interconnected about the magnetic core 610. The magnetic core 610 includes six conductive through vias 610a, 610b, 610c, 610d, 610e and 610f (shown in phantom lines in FIG. 6A) spaced and configured to provide interconnection between the inner contact sections of the leads of the top lead frame 320 and the bottom lead frame 660.

With particular reference to FIG. 6D, the bottom lead frame 660 includes a first set of leads 660a, 660b and 660c disposed on a first side of the lead frame 660 and a second set of leads 660e, 660f and 660g disposed on a second side of the lead frame 660. The lead 660a serves as a terminal lead and has an inner contact section 661a disposed on a plane A-A of the bottom lead frame 660. A side view of the power inductor 600 is shown in FIG. 6C and illustrates the referenced planes. Bottom leads 660b and 660c include inner contact sections 661b and 661c respectively disposed on the plane A-A. Bottom leads 660b and 660c further include outer contact sections 663b and 663c respectively disposed on the plane B-B that is parallel, and above, the plane A-A.

Lead 660e of the bottom lead frame 660 serves as a terminal lead and has an outer contact section 663e disposed on the plane B-B. Bottom leads 660f and 660g include inner contact sections 661f and 661g respectively disposed on the plane A-A. Bottom leads 660f and 660g further include outer contact sections 663f and 663g respectively disposed on the plane B-B.

A coil is formed about the magnetic core 610 as shown in FIG. 6A. The inner contact section 661a of the lead 660a is coupled to the inner contact section 321a of the lead 320a by means of via 610a. The outer contact section 323a of the lead 320a is coupled to the outer contact section 663b of the adjacent lead 660b. The inner contact section 661b of the lead 660b is coupled to the inner contact section 321b of the lead 320b by means of via 610b. The outer contact section 323b of the lead 320b is coupled to the outer contact section 663c of the adjacent lead 660c. The inner contact section 661c of the lead 660c is coupled to the inner contact section 321c of the lead 320c by means of via 610c. The outer contact section 323c of the lead 320c is coupled to the outer contact section 663d of the adjacent lead 660d. The lead 660d comprises a routing section 665d (FIG. 6D) that routes the coil circuit to connect the inner contact section 661d of the lead 660d to the inner contact section 321f of the lead 320f by means of via 610f. The outer contact section 323f of the lead 320f is coupled to the outer contact section 663g of the adjacent lead 660g. The inner contact section 661g of the lead 660g is coupled to the inner contact section 321e of the lead 320e by means of via 610e. The outer contact section 323e of the lead 320e is coupled to the outer contact section 663f of the adjacent lead 660f. The inner contact section 661f of the lead 660f is coupled to the inner contact section 321d of the lead 320d by means of via 610d. The outer contact section 323d of the lead 320d is coupled to the outer contact section 663e of the lead 660e.

The discrete power inductor 600 may include terminals 660a and 660e, the interconnection between the leads of the top and bottom lead frames 320 and 660 forming the coil through the magnetic core 610.

The discrete power inductor 600 may be encapsulated with an encapsulant to form a package (not shown). The encapsulant may include conventional encapsulating materials. Alternatively, the encapsulant may include materials incorporating magnetic powders such as ferrite particles to provide shielding and improved magnetic performance.

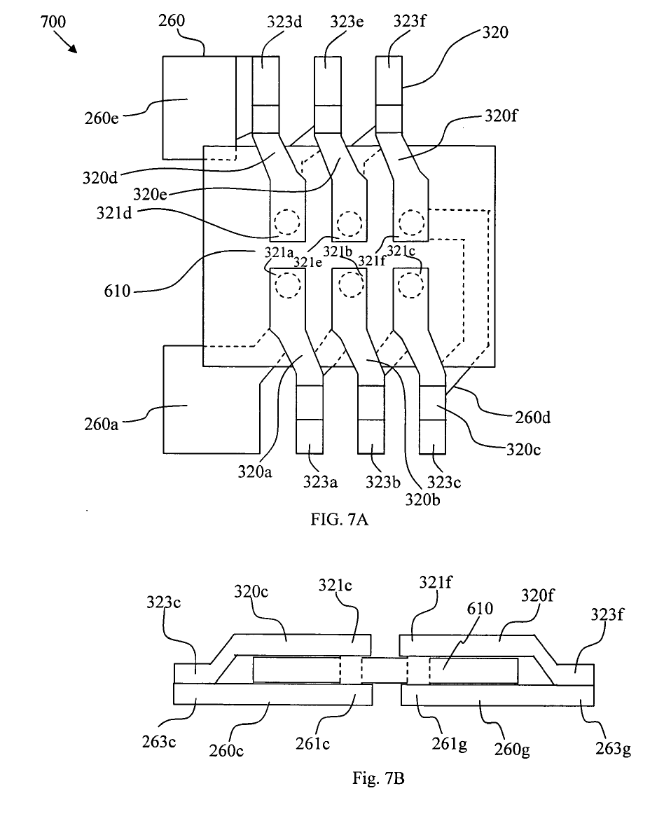

A seventh embodiment of a lead frame-based discrete power inductor generally designated 700 is shown in FIGS. 7A and 7B wherein portions of the leads of the bottom lead frame 260 are shown in phantom lines. The power inductor 700 comprises the magnetic core 610, the top lead frame 320 and the bottom lead frame 260. The magnetic core 610 includes six conductive through vias 610a, 610b, 610c, 610d, 610e and 610f spaced and configured to provide interconnection between the inner contact sections of the leads of the top lead frame 320 and the bottom lead frame 260.

A coil is formed through the magnetic core 610 as shown in FIG. 7A. The inner contact section 261a of the lead 260a is coupled to the inner contact section 321a of the lead 320a by means of via 610a. The outer contact section 323a of the lead 320a is coupled to the outer contact section 263b of the adjacent lead 260b. The inner contact section 261b of the lead 260b is coupled to the inner contact section 321b of the lead 320b by means of via 610b. The outer contact section 323b of the lead 320b is coupled to the outer contact section 263c of the adjacent lead 260c. The inner contact section 261c of the lead 260c is coupled to the inner contact section 321c of the lead 320c by means of via 610c. The outer contact section 323c of the lead 320c is coupled to the outer contact section 263d of the adjacent lead 260d. The lead 260d comprises a routing section 265d (FIG. 2C) that routes the coil circuit to connect the inner contact section 261d of the lead 260d to the inner contact section 321f of the lead 320f by means of via 610f. The outer contact section 323f of the lead 320f is coupled to the outer contact section 263g of the adjacent lead 260g. The inner contact section 261g of the lead 260g is coupled to the inner contact section 321e of the lead 320e by means of via 610e. The outer contact section 323e of the lead 320e is coupled to the outer contact section 263f of the adjacent lead 260f. The inner contact section 261f of the lead 260f is coupled to the inner contact section 321d of the lead 320d by means of via 610d. The outer contact section 323d of the lead 320d is coupled to the outer contact section 263e of the lead 260e.

The discrete power inductor 700 may include terminals 260a and 260e, the interconnection between the leads of the top and bottom lead frames 320 and 260 forming the coil through the magnetic core 610.

The discrete power inductor 700 may be encapsulated with an encapsulant to form a package (not shown). The encapsulant may include conventional encapsulating materials. Alternatively, the encapsulant may include materials incorporating magnetic powders such as ferrite particles to provide shielding and improved magnetic performance.

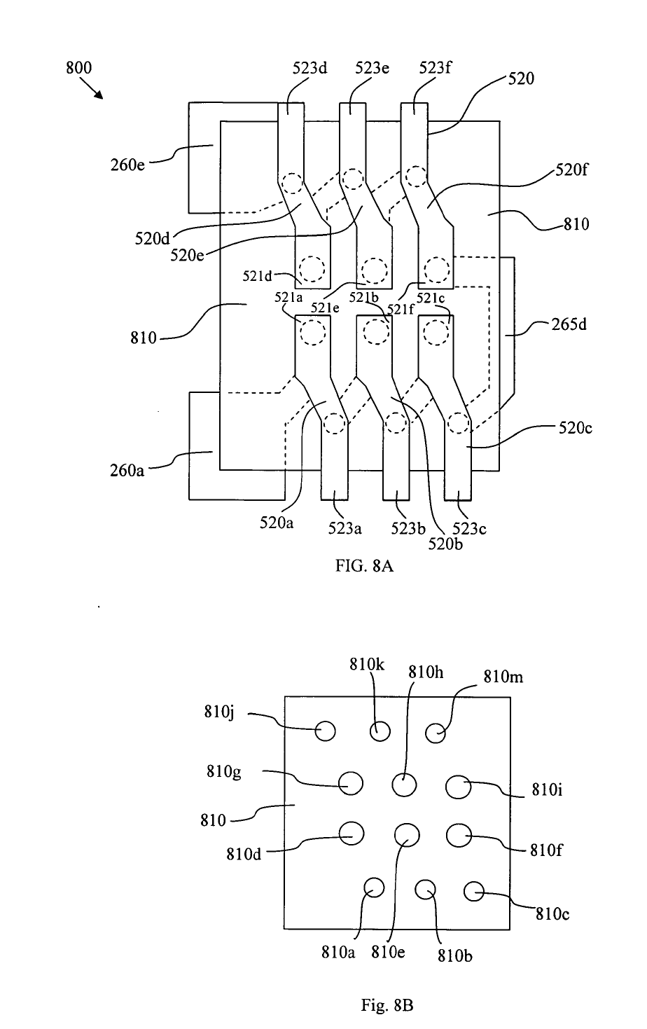

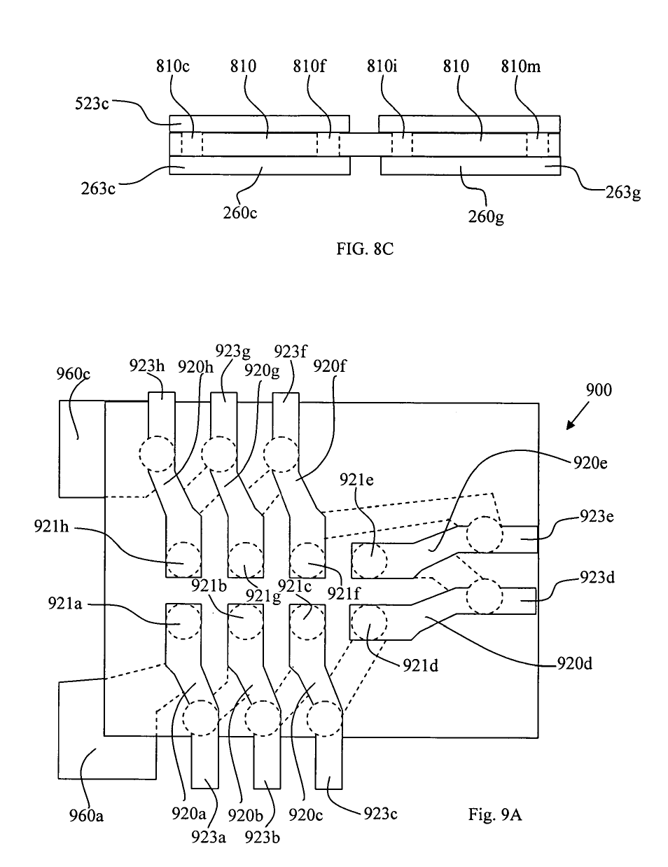

An eighth embodiment of a lead frame-based discrete power inductor generally designated 800 is shown in FIGS. 8A and 8C wherein portions of the leads of the bottom lead frame 260 are shown in phantom lines. The power inductor 800 comprises a magnetic core 810, the top lead frame 520 and the bottom lead frame 260. The magnetic core 810 includes twelve conductive through vias 810a, 810b, 810c, 810d, 810e, 810f, 810g, 810h, 810i, 810j, 810k and 810m (shown in phantom lines in FIG. 8A) spaced and configured to provide interconnection between the inner and outer contact sections of the leads of the top lead frame 520 and the bottom lead frame 260.

A coil is formed through the magnetic core 810 as shown in FIG. 8A. The inner contact section 261a of the lead 260a is coupled to the inner contact section 521a of the lead 520a by means of via 810d. The outer contact section 523a of the lead 520a is coupled to the outer contact section 263b of the adjacent lead 260b by means of via 810a. The inner contact section 261b of the lead 260b is coupled to the inner contact section 521b of the lead 520b by means of via 810e. The outer contact section 523b of the lead 520b is coupled to the outer contact section 263c of the adjacent lead 260c by means of via 810b. The inner contact section 261c of the lead 260c is coupled to the inner contact section 521c of the lead 520c by means of via 810f. The outer contact section 523c of the lead 520c is coupled to the outer contact section 263d of the adjacent lead 260d by means of via 810c. The lead 260d comprises a routing section 265d (FIG. 2C) that routes the coil circuit to connect the inner contact section 261d of the lead 260d to the inner contact section 521f of the lead 520f by means of via 810i. The outer contact section 263g of the lead 260g is coupled to the outer contact section 523f of the adjacent lead 520f by means of via 810m. The inner contact section 521e of the lead 520e is coupled to the inner contact section 261g of the lead 260g by means of via 810h. The outer contact section 263f of the lead 260f is coupled to the outer contact section 523e of the lead 520e by means of via 810k. The inner contact section 521d of the lead 520d is coupled to the inner contact section 2661f of the lead 260f by means of via 810g. The outer contact section 523d of the lead 520d is coupled to the outer contact section 262e of the lead 260e by means of via 810j.

The discrete power inductor 800 may include terminals 260a and 260e, the interconnection between the leads of the top and bottom lead frames 520 and 260 forming the coil through the magnetic core 810.

The discrete power inductor 800 may be encapsulated with an encapsulant to form a package (not shown). The encapsulant may include conventional encapsulating materials. Alternatively, the encapsulant may include materials incorporating magnetic powders such as ferrite particles to provide shielding and improved magnetic performance.

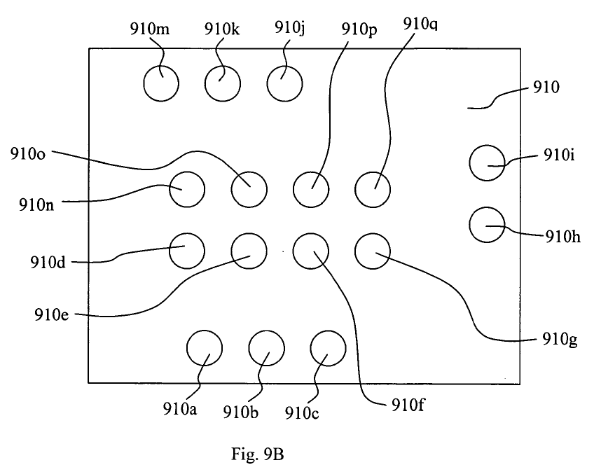

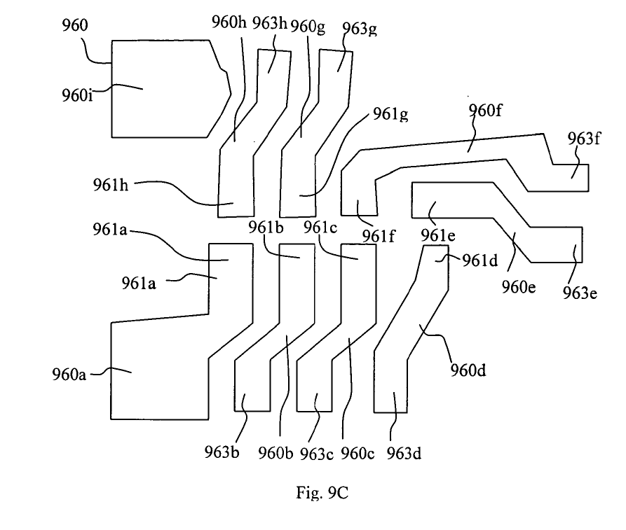

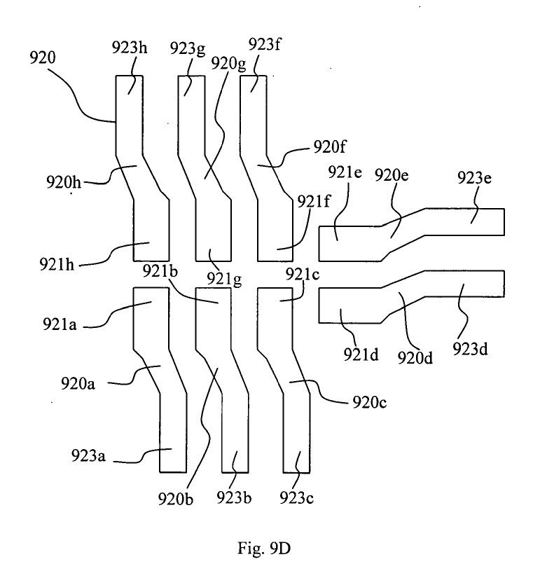

A ninth embodiment of a lead frame-based discrete power inductor generally designated 900 is shown in FIG. 9A wherein portions of the leads of a bottom lead frame 960 are shown in phantom lines. The power inductor 900 comprises a magnetic core 910 (FIG. 9B), a top lead frame 920 (FIG. 9D) and the bottom lead frame 960 (FIG. 9C). The top and bottom lead frames 920 and 960 provide additional leads (compared to those of the previously described embodiments) to thereby provide additional turns of the coil to the power inductor 900. The additional turns are shown disposed on a third side of the top and bottom lead frames 920 and 960.

The magnetic core 910 includes conductive through vias spaced and configured to provide interconnection between inner and outer contact sections of the leads of the top lead frame 920 and the bottom lead frame 960.

Top lead frame 920 includes leads 920a, 920b, 920c, 920d, 920e, 920f, 920g and 920h. Leads 920a, 920b, 920c, 920d, 920e, 920f, 920g and 920h each comprise planar inner contact sections 921a, 921b, 921c, 921d, 921e, 921f, 921g and 921h respectively. Leads 920a, 920b, 920c, 920d, 920e, 920f, 920g and 920h each further comprise planar outer contact sections 923a, 923b, 923c, 923d, 923e, 923f, 923g and 923h respectively.

Bottom lead frame 960 includes leads 960a, 960b, 960c, 960d, 960e, 960f, 960g, 960h and 960i. Bottom leads 960b, 960c, 960d, 960e, 960f, 960g and 960h each comprise planar inner contact sections 961b, 961c, 961d, 961e, 961f, 961g and 961h respectively. Bottom leads 960b, 960c, 960d, 960e, 960f, 960g, and 960h each further comprise planar outer contact sections 963b, 963c, 963d, 963e, 963f, 963g and 963h respectively. Terminal lead 960a includes a planar inner section 961a. Terminal lead 960i includes a planar outer contact section 963i.

The magnetic core 910 comprises a plurality of connective through vias 910a, 910b, 910c, 910d, 910e, 910f, 910g, 910h, 910i, 910j, 910k, 910m, 910n, 910o, 910p and 910q. Vias 910a, 910b, 910c, 910d, 910e, 910f, 910g, 910h, 910i, 910j, 910k, 910m, 910n, 910o, 910p and 910q are spaced and configured to provide interconnection between inner and outer contact sections of the leads of the top lead frame 920 and the bottom lead frame 960.

A coil is formed through the magnetic core 910 as shown in FIG. 9A. The inner section 961a of the lead 960a is coupled to the inner section 921a of the lead 920a by means of via 910d. The outer section 923a of the lead 920a is coupled to the outer section 963b of the lead 960b by means of via 910a. The inner section 961b of the lead 960b is coupled to the inner section 921b of the lead 920b by means of via 910e. The outer section 923b of the lead 920b is coupled to the outer section 963c of the lead 960c by means of via 910b. The inner section 961c of the lead 960c is coupled to the inner section 921c of the lead 920c by means of via 910f. The outer section 923c of the lead 920c is coupled to the outer section 963d of the lead 960d by means of via 910c. The inner section 961d of lead 960d is coupled to the inner section 921d of the lead 920d by means of via 910g. The outer section 923d of the lead 920d is coupled to the outer section 963e of the lead 960e by means of via 910h. The inner section 961e of the lead 960e is coupled to the inner section 921e of the lead 920e by means of via 910q. The outer section 923e of the lead 920e is coupled to the outer section 963f of the lead 960f by means of via 910i. The inner section 961f of the lead 960f is coupled to the inner section 921f of the lead 920f by means of via 910p. The outer section 923f of the lead 920f is coupled to the outer section 963g of the lead 960g by means of via 910j. The inner section 961g of the lead 960g is coupled to the inner section 921b of the lead 920b by means of via 910o. The outer section 923g of the lead 920g is coupled to the outer section 963h of the lead 960h by means of via 910k. The inner section 961h of the lead 960h is coupled to the inner section 921h of the lead 920h by means of via 910n. The outer section 923h of the lead 920h is coupled to the lead 960i by means of via 910m.

The discrete power inductor 900 may include terminals 960a and 960i, the interconnection between the leads of the top and bottom lead frames 920 and 960 forming the coil through the magnetic core 910.

The lead frame-based discrete power inductor of the invention provides a compact power inductor that maximizes inductance per unit area. Effective magnetic coupling is achieved using an efficient closed magnetic loop with a single magnetic core structure. The power inductor of the invention further provides a power inductor that combines a small physical size with a minimum number of turns to provide a small footprint and thin profile. Further, the power inductor of the invention is easily manufacturable in high volume using existing semiconductor packaging techniques at a low cost.

It is apparent that the above embodiments may be altered in many ways without departing from the scope of the invention. Further, various aspects of a particular embodiment may contain patentably subject matter without regard to other aspects of the same embodiment. Still further, various aspects of different embodiments can be combined together. Accordingly, the scope of the invention should be determined by the following claims and their legal equivalents.

1-10. (canceled)

11. A lead frame-based discrete power inductor comprising:
a top lead frame including a first side and a second side, the first side being disposed opposite the second side, the first side having a first set of leads and the second side having a second set of leads, each of the leads of the first set of leads and of the second set of leads having an inner contact section and an outer contact section;
a bottom lead frame including a first side and a second side, the first side being disposed opposite the second side, the first side having a first set of leads and the second side having a second set of leads, the first set of leads having a first terminal lead having an inner contact section and a terminal section, each of the remaining leads of the first set of leads having an inner contact section and an outer contact section, the second set of leads having a second terminal lead having an outer contact section and a terminal section, each of the remaining leads of the second set of leads having an inner contact section and an outer contact section;
a routing lead having an outer contact section disposed on the first side of the top lead frame and an inner contact section disposed on the second side of the top lead frame;
a magnetic core having a plurality of connective vias formed therethrough, the magnetic core being disposed between the top lead frame and the bottom lead frame such that the first side of the top lead frame is aligned with the first side of the bottom lead frame, the connective vias being spaced and arranged to provide interconnection between the inner contact section of first terminal lead and the inner contact sections of the remaining leads of the bottom lead frame first set of leads and respective inner contact sections of the top lead frame first set of leads and to the inner contact section of the routing lead and the inner contact sections of the remaining leads of the bottom lead frame second set of leads are coupled to respective inner contact sections of the top lead frame second set of leads, the outer contact sections of the top lead frame first set of leads being coupled to respective outer contact sections of the remaining leads of the bottom lead frame first set of leads and to the outer contact section of the routing lead, and the outer contact sections of the top lead frame second set of leads being coupled to respective outer contact sections of the remaining leads of the bottom lead frame second set of leads and to the outer contact section of the second terminal lead to provide a coil about the magnetic core.

12. The lead frame-based discrete inductor of claim 11, wherein the outer contact sections of the leads of the top lead frame first and second set of leads are disposed in a plane parallel to, and below, a plane of the inner contact sections, the outer contact sections of the remaining leads of the bottom lead frame first and second set of leads are disposed in a plane parallel to, and above, a plane of the inner contact sections, and the outer contact section of the routing lead is disposed in the plane parallel to, and above, the plane of the inner contact sections of the leads of the bottom lead frame.

13. The lead frame-based discrete inductor of claim 11, wherein the leads of the top lead frame first and second set of leads are bent about a portion of the magnetic core, the inner and outer contact sections thereof being disposed in a plane parallel to, and below a plane of the top lead frame, and the leads of the bottom lead frame first and second set of leads are planar.

14. The lead frame-based discrete power inductor of claim 11, wherein the magnetic core further comprises outer connective vias formed therethrough, the outer connective vias being spaced and arranged to provide interconnection between the outer contact sections of the top lead frame first set of leads and respective outer contact sections of the remaining leads of the bottom lead frame first set of leads and to the outer contact section of the routing lead, and to the outer contact sections of the top lead frame second set of leads and outer contact sections of the remaining leads of the bottom lead frame second set of leads and to the outer contact section of the second terminal lead to provide a closed magnetic circuit about the magnetic core.

15. The lead frame-based discrete power inductor of claim 14, wherein the leads of the top lead frame first and second set of leads are planar, and the leads of the bottom lead frame first and second set of leads are planar.

16. (canceled)

17. (canceled)

18. (canceled)

19. (canceled)

20. (canceled)

21. (canceled)

22. (canceled)

23-25. (canceled)
